(19) United States
(12) Patent Application Publication
(10) Pub. No.: US 2025/0008911 A1
(43) Pub. Date: Jan. 9, 2025

(54) VACUUM SUPPLY SOURCE

(71) Applicant: DELAVAL HOLDING AB, Tumba (SE)

(72) Inventors: Arkadiusz JOPEK, Tumba (SE); Maciej PAWLAK, Tumba (SE); Daniel TRYBULA, Tumba (SE)

(21) Appl. No.: 18/708,839

(22) PCT Filed: Dec. 19, 2022
(86) PCT No.: PCT/SE2022/051203

§ 371 Date: May 9, 2024

(30) Foreign Application Priority Data
Dec. 23, 2021 (SE) 2130376-3

(51) Int. Cl. A01J 5/04

(52) U.S. Cl. CPC A01J 5/048

(57) ABSTRACT

A vacuum supply source (100) includes a first vacuum pump (110) configured for providing vacuum pressure at a first maximum vacuum level; a second vacuum pump (120) configured for providing vacuum pressure at a second maximum vacuum level (P2), the first vacuum pump (110) having a larger capacity than the second vacuum pump (120); a flow limiter valve (140) arranged between the vacuum pumps (110, 120); a vacuum conduit (130), connected to the vacuum pumps (110, 120); and a controller (150) configured to obtain a request for a desired vacuum level (PR), determine a required pump speed of the first and/or second vacuum pumps (110, 120) in order to provide vacuum pressure at the desired vacuum level (PR), and adjust pump speed of the first and/or second vacuum pumps (110, 120) according to the determined required pump speed, via a control signal.

The invention refers to a vacuum supply source according to claim 1.

On a dairy farm, milk is typically extracted from the animals by attaching a teat cup with a liner on each teat of the animal and apply milking vacuum under the tip of the teat, in addition to a pulsation vacuum. Hereby, the rhythmical suckling of a calf is imitated so that sucking by the milking vacuum is interrupted by rhythmical motions, opening and closing of the liner, caused by the pulsation vacuum.

A recently developed methodology for efficient milk extraction is called Flow-Responsive™ Milking from DeLaval. This method includes a way of speeding up the milk extraction by applying a flow-adjusted vacuum. More precisely, when the milk flow of the animal is high (i.e. at peak milk flow that exceeds a certain milk flow threshold level), the milking vacuum may be additionally increased without negative impact on teat health and animal welfare. Thus, it may hereby be desired to increase the vacuum level of a system vacuum for a milking system (e.g. stationary milking parlour, rotary milking parlour or several automatic milking machines) by several kPa, for example to −55 kPa. The system vacuum level is maintained at such constant (high) level, while the milking vacuum at a specific milking point for an individual animal may be adjusted depending on the milk flow from the animal.

A problem on a dairy farm having a relatively larger sized vacuum pump with relatively higher capacity, in the form of for example a lobe vacuum pump, which is designed for generating more conventional system vacuum levels, is that the vacuum limit of the larger sized vacuum pump is lower (e.g. limit of −50 kPa) than the required vacuum level for achieving the faster milk extraction mentioned above. When approaching this limit, the larger sized (lobe) vacuum pump loses efficiency rapidly and may also wear rapidly if a farmer chooses to push the operation of this vacuum pump at or even above its designed vacuum limit for extended periods of time.

Another problem on a dairy farm provided with a relatively larger sized vacuum pump with relatively higher capacity is that it is rather difficult to adapt its operation to varying capacity demands from the milking system. The varying capacity demands depends on for instance varying air flow induced during operation of the milking system. Many vacuum pumps include the possibility of speed regulation, but the larger sized vacuum pumps are relatively slower in their response to such varying capacity demands due to higher inertia. Hence, instead of adapting the speed of this vacuum pump to varying capacity demands, the system vacuum level is typically maintained by operating (opening/closing) a vacuum regulating valve to let in air into the vacuum system if the system vacuum level increases (due to low capacity demand from the milking system) and to shut off the air supply if the system vacuum level drops (due to higher capacity demand from the milking system). However, the larger sized vacuum pump is thereby running at higher speed than necessary in low demand situations, while the vacuum regulating valve is admitting air into the vacuum system, which is not an energy efficient way of maintaining the vacuum level.

Hence, for a dairy farm to enable Flow-Responsive™ Milking, it would be beneficial to provide an upgrade or change of a currently used vacuum pump set-up for a new one having an enhanced performance, which enables higher system vacuum levels. In addition, it would be beneficial to provide enhanced performance by enabling a more energy efficient way of regulating the system vacuum level.

It is an object of the present invention to provide a vacuum supply source that solves the problems mentioned above by providing an enhanced vacuum pump set-up concept for providing a desired vacuum level to a milking system.

This object is achieved by a vacuum supply source for providing a vacuum pressure to a milking system, according to claim 1. The inventive vacuum supply source is aimed at providing a vacuum pressure to a milking system at a desired vacuum level by adjusting the pump speed of at least one of the vacuum pumps of the vacuum supply source.

The vacuum supply source comprises a first vacuum pump configured for providing a maximum vacuum pressure at a first maximum vacuum level to the milking system. The vacuum supply source further comprises a second vacuum pump configured for providing a maximum vacuum pressure at a second maximum vacuum level to the milking system. The first vacuum pump hereby has a larger capacity than the second vacuum pump. Also, the first maximum vacuum level of vacuum pressure thereby equals less pressure below atmospheric pressure than the second maximum vacuum level.

The vacuum supply source also comprises a flow limiter valve arranged between the first vacuum pump and the second vacuum pump. In addition, the vacuum supply source comprises a vacuum conduit, connected to the first vacuum pump and the second vacuum pump, configured to provide vacuum pressure, generated by the first vacuum pump and/or the second vacuum pump to the milking system. The first and second vacuum pumps can be connected in parallel to the vacuum conduit with the flow limiter valve arranged therebetween.

Furthermore, the vacuum supply source in addition comprises at least one controller communicatively connected to the first vacuum pump and the second vacuum pump. The at least one controller is configured to obtain a request for a desired vacuum level to be provided to the milking system. The at least one controller is also configured to monitor the vacuum level and determine a required pump speed of the first vacuum pump and/or the second vacuum pump in order to provide a vacuum pressure at the desired vacuum level. The at least one controller is hereby configured to adjust a pump speed of the first vacuum pump and/or the second vacuum pump according to the determined respectively required pump speed, via a control signal, and thereby provide vacuum pressure at the desired vacuum level to the milking system. The vacuum level monitoring is arranged in a known manner by providing at least one vacuum sensor on the vacuum conduit, wherein the vacuum sensor(s) is connected to the at least one controller configured to determine the required pump speed in order to achieve the desired vacuum level.

In this way, by providing a second vacuum pump and the other features of the vacuum supply source, an upgrading or change of an existing vacuum system is enabled in order to achieve Flow-Responsive™ Milking with higher system vacuum levels by adding a high vacuum zone with the second vacuum pump onto the existing installation. This is achieved by the flow limiter valve, which is arranged so that the first and second vacuum pumps operate in a low vacuum zone and a high vacuum zone respectively. In other words, the first (larger) vacuum pump designed for larger capacity yet lower vacuum limit may operate in its intended operating range, while the second (smaller) vacuum pump designed for lower capacity yet higher vacuum limit may operate in a higher vacuum zone to provide the higher system vacuum level. In addition, the vacuum supply source also enables a beneficial speed regulation of the second pump with relatively faster response to varying capacity demands due to its relatively lower inertia.

In an embodiment, the second vacuum pump of the vacuum supply source is connected via a branch conduit to the vacuum conduit at a connection point closer to the milking system than the connection point of the first vacuum pump. In other words, the first and second vacuum pumps are arranged in parallel, in such a way that the second vacuum pump is connected via the branch conduit to the vacuum conduit at a location that is closer to the milking system than the connection point of the first vacuum pump.

In a further embodiment, the at least one controller of the vacuum supply source is configured to maintain the level of the vacuum pressure provided to the milking system at the desired vacuum level, when the desired vacuum level is higher than the first maximum vacuum level, by adjusting the pump speed of the first vacuum pump and the second vacuum pump. Both the first vacuum pump and the second vacuum pump are in this way speed regulated to maintain a low and high vacuum level respectively in their low and high vacuum zones respectively, wherein the high vacuum zone provides the (higher) desired vacuum level (for Flow-Responsive™ Milking) to the milking system. A vacuum level monitoring of the at least one controller may hereby be achieved by arranging a first vacuum sensor in the low vacuum zone and a second vacuum sensor in the high vacuum zone.

In another embodiment, the at least one controller is configured to maintain the level of the vacuum pressure provided to the milking system at the desired vacuum level by keeping the pump speed of the first vacuum pump at a constant level, while adjusting the pump speed of the second vacuum pump, whereby the pump speed of the second pump is adapted to varying capacity demands from the milking system. The first (larger) vacuum pump hereby provides a more or less constant basic capacity to the milking system, wherein the second (smaller) vacuum pump is speed regulated to handle the varying capacity demands from the milking system. A desired vacuum level can in this way be maintained in said energy efficient manner by merely controlling the speed on the second (smaller) vacuum pump, which has relatively lower inertia compared to the first (larger) vacuum pump. The vacuum system may still comprise a vacuum regulating valve to safeguard that the vacuum level does not exceed a specific threshold at or above the desired vacuum level. However, due to the quick speed regulation of the second vacuum pump, the vacuum regulating valve will not activate as often or much to let air into the vacuum system.

Thus, when the monitored vacuum level provided to the milking system decreases, the pump speed of the second vacuum pump is increased. The vacuum pressure provided to the milking system may thereby be maintained or regulated by adjusting the pump speed of the second vacuum pump, which is less energy demanding than if for example one larger high capacity vacuum pump would be used together with a vacuum regulating valve instead.

In a further embodiment, the vacuum supply source comprises an automatically controlled valve, communicatively connected to the controller, wherein the automatically controlled valve is configured to adjust the vacuum pressure provided to the milking system. The controller is hereby configured to monitor and maintain the level of the vacuum pressure provided to the milking system at the desired vacuum level by adjusting the automatically controlled valve while keeping pump speed of the first vacuum pump at a first constant level and keeping pump speed of the second vacuum pump at a second constant level. In this way the automatically controlled valve is beneficially operated together with the controller of the vacuum pumps for stable vacuum regulation. In for instance certain operating conditions when the vacuum/capacity demand from the milking system is low, while the second vacuum pump is running at its lowest possible speed and the monitored vacuum level nevertheless exceeds the desired vacuum level, the automatically operated valve may be opened to admit air into the vacuum conduit. The automatically controlled valve may be a modulating or proportional valve to proportionally open/close and thereby admit varying amounts of air for adjusting the vacuum level. This embodiment is beneficial in relation to the provision of an independent mechanical vacuum regulating valve, which can result in unstable regulation where the pump controller is fighting against the independent mechanical vacuum regulating valve. Instead the automatically controlled valve (preferably an electric valve), which is controlled by the same controller as the vacuum pumps, on the input from the vacuum sensor connected to the vacuum conduit, will enable a more stable and energy efficient vacuum regulation. A mechanical vacuum regulating valve is also more sensitive to ambient pressure/temperature changes, whereby the mechanical vacuum regulating valve may require frequent manual adjustments.

By this arrangement, an instant control of the automatically controlled valve and thereby also the vacuum pressure in the vacuum conduit to the milking system may be made.

In an embodiment, the controller is configured to adjust the automatically controlled valve when the pump speed or the desired vacuum level is lower than a predetermined threshold level. In this way the automatically controlled valve is only activated at certain operating conditions when for instance the second pump is running at minimum speed or the desired vacuum level is set below a certain threshold level, which may entail that the second pump running at such minimum speed or is shut-off.

In a further embodiment, the first vacuum pump comprises a lobe vacuum pump and the second vacuum pump comprises a vane vacuum pump.

Optionally or alternatively, the first vacuum pump may comprise a lobe vacuum pump and the second vacuum pump may comprise a claw vacuum pump.

In an embodiment of the vacuum supply source, the first maximum vacuum level is within a range of −45 kPa to −50 kPa below atmospheric pressure, or more specifically at about −50 kPa below atmospheric pressure, and the second maximum vacuum level is within a range of at least 5 to 10 kPa additionally lower than the first maximum vacuum level below atmospheric pressure. The second maximum vacuum level of the second vacuum pump may of course thereby be significantly higher than first maximum vacuum level of the first vacuum pump. Hence, the second vacuum pump may for instance be designed with a second maximum vacuum level in a range of −70 kPa to −80 kPa, whereas the first vacuum pump is designed with a first maximum vacuum level of said −50 kPa.

Other advantages and additional novel features will become apparent from the subsequent detailed description.

### FIGURES

Embodiments of the invention will now be described in further detail with reference to the accompanying Figures, in which:

FIG. 1 illustrates an embodiment of a vacuum supply source in an agricultural environment comprising a milking system.

FIG. 2A illustrates vacuum pressure levels provided to the milking system according to an embodiment.

FIG. 2B illustrates vacuum pressure levels provided to the milking system according to an embodiment.

FIG. 3 conceptually illustrates vacuum pressure capacity of a vacuum supply source according to an embodiment.

### DETAILED DESCRIPTION

Embodiments of the invention described herein are defined as a vacuum supply source, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

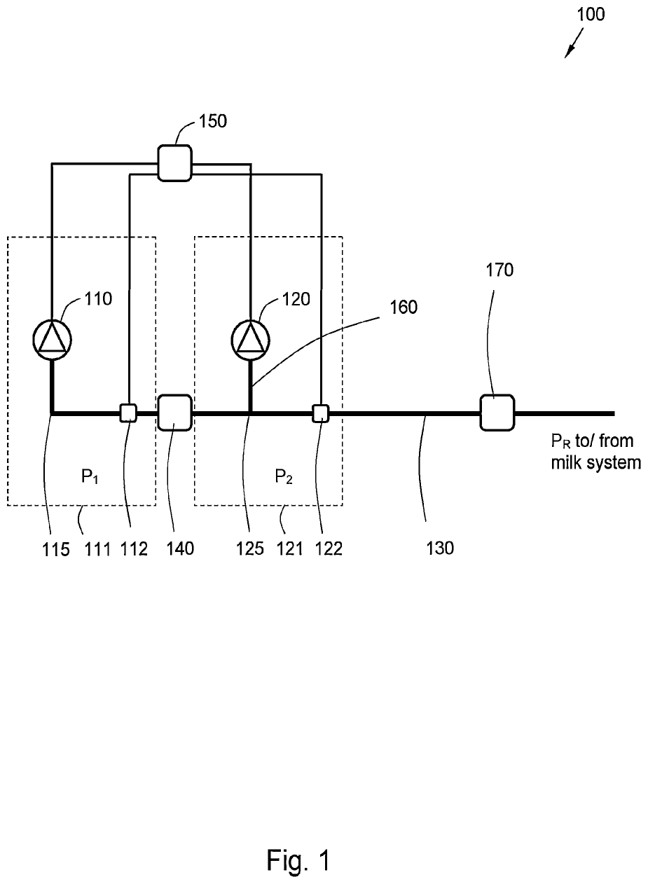

FIG. 1 schematically illustrates an embodiment of a vacuum supply source 100 in a dairy farm environment. The vacuum supply source 100 comprises a first vacuum pump 110 and a second vacuum pump 120. The first vacuum pump 110 is the main pump to provide a basic capacity and the additional second vacuum pump 120 functions as a higher vacuum generator.

The vacuum supply source 100 may be divided into two distinct zones 111, 121; a low vacuum zone 111, wherein the first vacuum pump 110 is designed to provide a maximum vacuum pressure at a first maximum vacuum level P₁; and a high vacuum zone 121, wherein the second vacuum pump 120 is designed to provide a maximum vacuum pressure at a second maximum vacuum level P₂. The first maximum vacuum level P₁ may for example be within a range of −45 kPa to −50 kPa below atmospheric pressure. In this embodiment the first maximum vacuum pressure of the first vacuum pump is −50 kPa below atmospheric pressure. The second maximum vacuum level P₂ of the second vacuum pump 120 may be designed within a range of at least 5-10 kPa additionally lower than the first maximum vacuum level P₁ below atmospheric pressure. Thus, the second maximum vacuum level P₂ may be within a range of at least −50 kPa to −60 kPa below atmospheric pressure, depending on the first maximum vacuum level P₁. In this embodiment the second vacuum pump 120 is designed to provide a significantly higher second maximum vacuum pressure P₂ at about −80 kPa.

The system vacuum pressure for the milking system is maintained substantially constant over time during a milking session.

The herein used expressions “vacuum pressure”, “fluid pressure”, “milking vacuum” and/or “system vacuum pressure” respectively, refers to under-pressure/lower pressure in comparison with the environmental atmospheric pressure. A vacuum pressure level of −10 kPa thus means a vacuum pressure level which is 10 kPa lower than the environmental atmospheric pressure.

The first vacuum pump 110 has a larger capacity than the second vacuum pump 120. Hence, at a given vacuum pressure level, the first vacuum pump is evacuating more litres of air per minute than the second vacuum pump. However, the first maximum vacuum level P₁ of the first vacuum pump 110 equals less pressure below atmospheric pressure than the second maximum vacuum level P₂ of the second vacuum pump 120.

The first vacuum pump 110 in this embodiment is a lobe vacuum pump and the second vacuum pump 120 is a vane vacuum pump. However, in other embodiments, the first vacuum pump may be a lobe vacuum pump and the second vacuum pump may be a claw vacuum pump. In yet some alternative embodiments, both the first vacuum pump and the second vacuum pump may be a vane vacuum pump or a claw vacuum pump.

Also other pump configurations are possible in other embodiments, wherein the first vacuum pump 110 however has a larger capacity than the second vacuum pump 120, and the first maximum vacuum level P₁ of vacuum pressure equals less pressure below atmospheric pressure than the second maximum vacuum level P₂.

The vacuum supply source 100 also comprises a flow limiter valve 140, arranged between the first vacuum pump 110 and the second vacuum pump 120. In addition, the vacuum supply source 100 also comprises a vacuum conduit 130, connected to the first vacuum pump 110 and the second vacuum pump 120. The first and second vacuum pumps 110, 120 are arranged in parallel to the vacuum conduit 130 with the flow limiter valve 140 arranged in between. The vacuum conduit 130 is configured to provide vacuum pressure, generated by the first vacuum pump 110 and the second vacuum pump 120 to the milking system.

The opening/closure of the flow limiter valve 140 may be adjusted based on a difference in vacuum pressure between the low vacuum zone 111 and the high vacuum zone 121, on the respective side of the flow limiter valve 140. In case the flow limiter valve 140 is fully opened, the vacuum pressure in the low vacuum zone 111 and the high vacuum zone 121, will be equal.

The second vacuum pump 120 is connected via a branch conduit 160 to the vacuum conduit 130 at a connection point 125 closer to the milking system than the connection point 115 of the first vacuum pump 110.

The vacuum supply source 100 comprises at least one controller 150, communicatively connected to the first vacuum pump 110 and the second vacuum pump 120. In some embodiments, one single controller 150 may be applied for controlling both the first vacuum pump 110 and the second vacuum pump 120. In other embodiments, one separate controller 150 may be used for controlling the first vacuum pump 110 and the second vacuum pump 120, respectively.

The at least one controller 150 is configured to obtain a request for a desired vacuum level PR to be provided to the milking system. The desired vacuum level PR may for example be set automatically into the controller or manually by an operator when wanting to apply vacuum during Cleaning In Place (CIP) of the milk line/milking equipment of the milking system, and/or for implementing Flow-Responsive™ Milking including a relatively higher vacuum level for faster milking in the milking system. The desired vacuum level PR may also be obtained by control logic of the milking system, or a cleaning system of the milking system for example.

Also, the at least one controller 150 is configured to monitor the vacuum level and determine a required pump speed of the first vacuum pump 110 and/or the second vacuum pump 120 in order to provide a vacuum pressure at the desired vacuum level PR. The at least one controller 150 is additionally configured to adjust a pump speed of the first vacuum pump 110 and/or the second vacuum pump 120 according to the determined respectively required pump speed, via a control signal, and thereby provide vacuum pressure at the desired vacuum level PR to the milking system.

The vacuum supply source 100 comprises a first vacuum pressure sensor 112 for measuring the vacuum level within the low vacuum zone 111. The vacuum supply source 100 further comprises a second vacuum pressure sensor 122 for measuring the vacuum level within the high vacuum zone 121. The first vacuum pressure sensor 112 and the second vacuum pressure sensor 122 is communicatively connected, wired or wirelessly, to the at least one controller 150 of the vacuum supply source 100. The at least one controller 150 may continuously or at certain time intervals; or when an explicit request is made, measure the vacuum level within the low vacuum zone 111 via the first vacuum pressure sensor 112 and the vacuum level within the high vacuum zone 121 via second vacuum pressure sensor 122.

Thus, the first vacuum sensor 112 associated with the first vacuum pump 110 is located downstream the flow limiter 140 in this embodiment, for regulating vacuum level in the low vacuum zone 111. The second vacuum sensor 122 associated with the second vacuum pump 120 is located upstream the flow limiter 140, for regulating vacuum level in high vacuum zone 121.

The at least one controller 150 may then monitor the respective vacuum level for making a comparison with a desired respective vacuum pressure in the low vacuum zone 111 and/or the high vacuum zone 121. Based on the outcome of the made comparison, the at least one controller 150 may then generate and send a command to either increase or decrease the respective outcome of the first vacuum pump 110 (in the low vacuum zone 111) and/or the second vacuum pump 120 (in the high vacuum zone 121).

Thanks to the provided solution, an existing installation at a dairy farm, having one vacuum pump, could easily be upgraded to enable higher vacuum milking by adding the high vacuum zone 121 with the second vacuum pump 120 onto the existing installation.

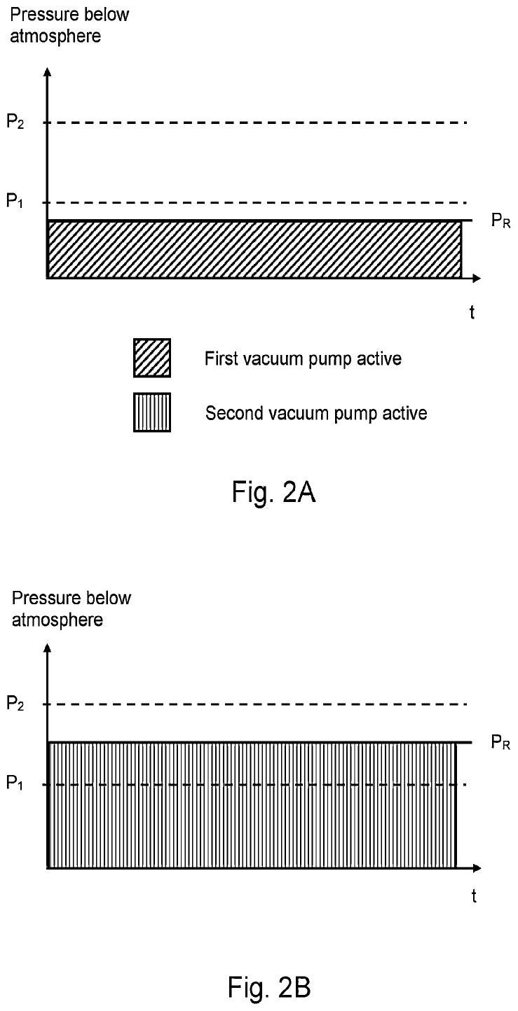

In some embodiments, wherein the desired vacuum level PR of the milking system is lower than the first maximum vacuum level P₁, the at least one controller 150 may be configured to monitor and maintain the level of the vacuum pressure provided to the milking system by operating the first vacuum pump 110. This situation is schematically illustrated in FIG. 2A, wherein the at least one controller 150 merely operates the first vacuum pump 110 while the second vacuum pump 120 is shut off.

However, when the desired vacuum level PR of the milking system exceeds the first maximum vacuum level P₁, the at least one controller 150 is configured to maintain the level of the vacuum pressure provided to the milking system by adjusting the pump speed of the first vacuum pump 110 and the second vacuum pump 120, as schematically illustrated in FIG. 2B.

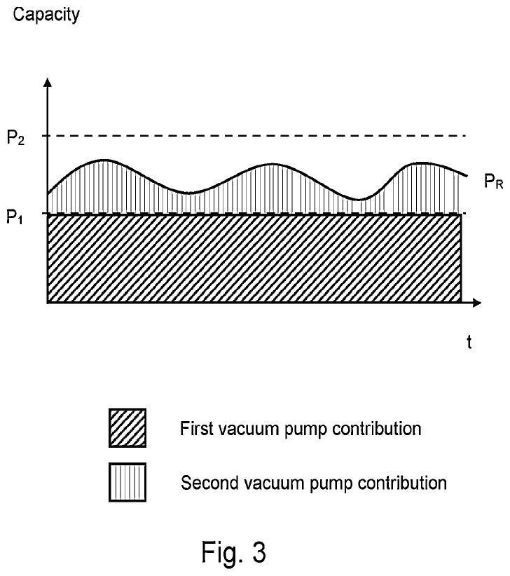

The at least one controller 150 may be configured to monitor and maintain the level of the vacuum pressure provided to the milking system at the desired vacuum level PR by keeping the pump speed of the first vacuum pump 110 at a constant level, while adjusting the pump speed of the second vacuum pump 120, whereby the pump speed of the second pump is adapted to varying capacity demands from the milking system. This situation is schematically illustrated in FIG. 3.

The vacuum supply source 100 may comprise an automatically controlled valve 170. The automatically controlled valve 170 may be electronically operated, in some embodiments. The automatically controlled valve 170 is configured to adjust the vacuum pressure provided to the milking system.

The second vacuum pump 120 may serve the variable capacity area of the system. The first vacuum pump 110 may run at a constant speed to provide a basic capacity performance. The automatically controlled valve 170 may only be activated when there is a small demand for capacity or vacuum in the system, when the second vacuum pump 120 is running at minimum speed. High energy savings may be achieved compared to systems equipped with vacuum regulating valves for regulating the vacuum level by admitting air into the vacuum conduit, while simultaneously running the vacuum pump at higher speeds than necessary. Thus, a minimization or at least reduction of energy losses compared to the opening of such vacuum regulating valves in the vacuum system is achieved.

Also, the vacuum supply source 100 is resistant to the influence of external factors such as ambient pressure and temperature compared to conventional systems based on mechanical vacuum regulating valves.

The at least one controller 150 may be configured to maintain the level of the vacuum pressure provided to the milking system at the desired vacuum level PR by adjusting the automatically controlled valve 170 while keeping pump speed of the first vacuum pump 110 at a first constant level and keeping pump speed of the second vacuum pump 120 at a second constant level.

The at least one controller 150 may in addition be configured to adjust the automatically controlled valve 170 when the pump speed of the second pump or the desired vacuum level PR is lower than a predetermined threshold level.

The automatically controlled valve 170 may be configured for activation only when there is a small demand for vacuum from the milking system and the second vacuum pump 120 is running at minimum speed.

The at least one controller 150 is communicatively connected to the first and second vacuum sensors 112, 122 and may be configured to further control the flow limiter 140 in the form of an adjustable valve, for instance via a wireless connection based on radio or optical technique, or a wired connection implemented by electric cable or optic fibre. In this way, the vacuum difference between the high and low vacuum zones can be regulated by controlling the adjustable flow limiter valve 140.

The at least one controller 150 may comprise one or more instances of a processing circuit/circuitry, i.e. a Central Processing Unit (CPU), an Application Specific Integrated Circuit (ASIC), a microprocessor, a Graphics Processing Unit (GPU), an Electronic Control Unit (ECU), or other processing logic that may interpret and execute instructions. The herein utilised expression “processing circuitry” may thus represent a processing circuitry comprising a plurality of processing circuits, such as, e.g., any, some or all of the ones enumerated above.

The at least one controller 150 may also be configured to, repeatedly during the milking session, obtain vacuum pressure level measurements from the first and second vacuum sensors, and, based on the obtained vacuum level difference, generate and provide a control signal to the adjustable flow limiter valve 140, to adjust the adjustable passage to achieve a desired vacuum level difference between the low and high vacuum zones. The control signal may for example comprise an electrical control signal.

By adjusting the adjustable passage of the adjustable flow limiter valve 140, the vacuum pressure difference between a location upstream and downstream the flow limiter valve 140 is thereby correspondingly adjusted.

The at least one controller 150 may be configured to generate and provide the control signal to the adjustable flow limiter valve 140 in order to maintain the vacuum pressure downstream of the controllable valve arrangement 140 in the vacuum conduit within a suitable operating range of the first vacuum pump, in some embodiments.

The direction and/or size of the adjustment of the adjustable passage, i.e. increasing or decreasing/closing the passage may be determined by the at least one controller 150 in several distinct ways in different embodiments. For example, the at least one controller 150 may compare the obtained respective pressure level measurement with a desired vacuum pressure level; or alternatively a desired vacuum pressure interval.

When the monitored pressure level measurement is lower (for example-48 kPa below atmospheric pressure) than the desired vacuum pressure level PR (for example-50 kPa below atmospheric pressure), the at least one controller 150 may generate and provide a control signal to the second pump 120 to increase in speed in order to provide an increased vacuum level, i.e. more under-pressure, upstream the flow limiter valve 140.

Alternatively, when the monitored pressure level measurement is higher (for example −52 kPa below atmospheric pressure) than the desired vacuum pressure level PR (for example −50 kPa below atmospheric pressure), the at least one controller 150 may generate and provide a control signal to the second pump 120 to decrease in speed in order to provide a decreased vacuum level, i.e. less under-pressure, upstream the flow limiter valve 140. In this embodiment the first vacuum pump 110 may run at constant speed, whereby the second pump 120 is speed regulated for varying capacity demands from the milking system.

Hereby, a substantially constant vacuum pressure level at the desired vacuum pressure level P_{R} may be maintained in the milking system.

The at least one controller 150 is in general configured to perform the above-described procedure in an automatic manner by executing a computer program. Therefore, according to some embodiment, the at least one controller 150 may comprise a memory unit, i.e., non-volatile data carrier, storing the computer program, which, in turn, may contain software for making a processing circuitry in the form of at least one processor in the at least one controller 150 to execute the above-described actions when the computer program is run on the processing circuitry.

The vacuum supply source 100 and/or the at least one controller 150 may also comprise or be communicatively connected to a database or data storage memory in some embodiments, communicatively connected to the at least one controller 150. The optional database may be configured to store data, for example related to various desired vacuum pressure levels P_{R}, such as for example a desired vacuum pressure level for milking and another desired vacuum pressure level for cleaning or a desired vacuum pressure interval for milking, such as desired vacuum pressure levels for milking different groups of animals at different points in time during the day, etc.

Thanks to the disclosed concept, a methodology has been developed towards an efficient milk extraction by ensuring an energy efficient and stable vacuum pressure level for a milking system.

The terminology used in the description of the embodiments as illustrated in the accompanying drawings is not intended to be limiting of the described vacuum supply source 100, milking system; at least one controller 150 and/or computer program. Various changes, substitutions and/or alterations may be made, without departing from invention embodiments as defined by the appended claims.

The various illustrated embodiments depicted in FIGS. 1-3, and/or discussed in the corresponding respective section of the description may with advantage be combined with each other, for example by mixing and compiling features of some or all of the described embodiments, thereby achieving additional advantages.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g., a processor may fulfil the functions of several items recited in the claims. The mere fact that certain measures or features are recited in mutually different dependent claims, illustrated in different figures or discussed in conjunction with different embodiments does not indicate that a combination of these measures or features cannot be used to advantage.

1. A vacuum supply source (100) for providing a vacuum pressure to a milking system, the vacuum supply source (100) comprising:
a vacuum conduit (130) connected to provide vacuum pressure to the milking system;
a first vacuum pump (110) connected to the vacuum conduit (130) and configured for providing a maximum vacuum pressure at a first maximum vacuum level (P1) to the milking system via the vacuum conduit (130);
a second vacuum pump (120) connected to the vacuum conduit (130) and configured for providing a maximum vacuum pressure at a second maximum vacuum level (P2) to the milking system via the vacuum conduit (130),
wherein the first vacuum pump (110) has a larger capacity than a capacity of the second vacuum pump (120), and the first maximum vacuum level (P1) of vacuum pressure equals less pressure below atmospheric pressure than the second maximum vacuum level (P2);
an adjustable flow limiter valve (140) arranged on the vacuum conduit (130) between the first vacuum pump (110) and the second vacuum pump (120);
at least one controller (150) communicatively connected to the first vacuum pump (110) and the second vacuum pump (120), wherein the at least one controller (150) is configured to:
obtain a request for a desired vacuum level (PR) to be provided to the milking system,
monitor the vacuum level and determine a required pump speed of the first vacuum pump (110) and/or the second vacuum pump (120) in order to provide a vacuum pressure at the desired vacuum level (PR), and
adjust a pump speed of the first vacuum pump (110) and/or the second vacuum pump (120) according to the determined respectively required pump speed, via a control signal, and thereby provide vacuum pressure at the desired vacuum level (PR) to the milking system.

2. The vacuum supply source (100) according to claim 1, wherein the second vacuum pump (120) is connected via a branch conduit (160) to the vacuum conduit (130) at a connection point (125) closer to the milking system than the connection point (115) of the first vacuum pump (110).

3. The vacuum supply source (100) according to claim 1, wherein the at least one controller (150) is configured to maintain the level of the vacuum pressure provided to the milking system at the desired vacuum level (PR), when the desired vacuum level (PR) is higher than the first maximum vacuum level (P1), by adjusting the pump speed of the first vacuum pump (110) and the second vacuum pump (120).

4. The vacuum supply source (100) according to claim 1, wherein the at least one controller (150) is configured to maintain the level of the vacuum pressure provided to the milking system at the desired vacuum level (PR) by keeping the pump speed of the first vacuum pump (110) at a constant level, while adjusting the pump speed of the second vacuum pump (120), whereby the pump speed of the second pump is adapted to varying capacity demands from the milking system.

5. The vacuum supply source (100) according to claim 1, further comprising:
an automatically controlled valve (170) communicatively connected to the controller (150),
wherein the automatically controlled valve (170) is configured to adjust the vacuum pressure provided to the milking system, and
wherein the controller (150) is configured to monitor and maintain the level of the vacuum pressure provided to the milking system at the desired vacuum level (PR) by adjusting the automatically controlled valve (170) while keeping pump speed of the first vacuum pump (110) at a first constant level and keeping pump speed of the second vacuum pump (120) at a second constant level.

6. The vacuum supply source (100) according to claim 5, wherein the controller (150) is configured to adjust the automatically controlled valve (170) when the pump speed or the desired vacuum level (PR) is lower than a predetermined threshold level.

7. The vacuum supply source (100) according to claim 1, wherein the first vacuum pump (110) comprises a lobe vacuum pump and the second vacuum pump (120) comprises a vane vacuum pump.

8. The vacuum supply source (100) according to claim 1, wherein the first vacuum pump (110) comprises a lobe vacuum pump and the second vacuum pump (120) comprises a claw vacuum pump.

9. The vacuum supply source (100) according to claim 1, wherein both the first vacuum pump (110) and the second vacuum pump (120) comprises a claw vacuum pump.

10. The vacuum supply source (100) according to claim 1, wherein the first maximum vacuum level (P1) is within a range of −45 kPa to −50 kPa below atmospheric pressure, and wherein the second maximum vacuum level (P2) is within a range of at least 5 to 10 kPa additionally lower than the first maximum vacuum level (P1) below atmospheric pressure.

11. The vacuum supply source (100) according to claim 2, wherein the at least one controller (150) is configured to maintain the level of the vacuum pressure provided to the milking system at the desired vacuum level (PR), when the desired vacuum level (PR) is higher than the first maximum vacuum level (P1), by adjusting the pump speed of the first vacuum pump (110) and the second vacuum pump (120).

12. The vacuum supply source (100) according to claim 2, wherein the at least one controller (150) is configured to maintain the level of the vacuum pressure pro-vided to the milking system at the desired vacuum level (PR) by keeping the pump speed of the first vacuum pump (110) at a constant level, while adjusting the pump speed of the second vacuum pump (120), whereby the pump speed of the second pump is adapted to varying capacity demands from the milking system.

13. The vacuum supply source (100) according to claim 2, further comprising:
an automatically controlled valve (170) communicatively connected to the controller (150),
wherein the automatically controlled valve (170) is configured to adjust the vacuum pressure provided to the milking system, and
wherein the controller (150) is configured to monitor and maintain the level of the vacuum pressure provided to the milking system at the desired vacuum level (PR) by adjusting the automatically controlled valve (170) while keeping pump speed of the first vacuum pump (110) at a first constant level and keeping pump speed of the second vacuum pump (120) at a second constant level.

14. The vacuum supply source (100) according to claim 3, further comprising:
an automatically controlled valve (170) communicatively connected to the controller (150),
wherein the automatically controlled valve (170) is configured to adjust the vacuum pressure provided to the milking system, and
wherein the controller (150) is configured to monitor and maintain the level of the vacuum pressure provided to the milking system at the desired vacuum level (PR) by adjusting the automatically controlled valve (170) while keeping pump speed of the first vacuum pump (110) at a first constant level and keeping pump speed of the second vacuum pump (120) at a second constant level.

15. The vacuum supply source (100) according to claim 2, wherein the first vacuum pump (110) comprises a lobe vacuum pump and the second vacuum pump (120) comprises one of a claw vacuum pump and a vane pump.

16. The vacuum supply source (100) according to claim 2, wherein both the first vacuum pump (110) and the second vacuum pump (120) comprises a claw vacuum pump.

17. The vacuum supply source (100) according to claim 2, wherein the first maximum vacuum level (P1) is −50 kPa below atmospheric pressure, and wherein the second maximum vacuum level (P2) is within a range of at least 5 to 10 kPa additionally lower than the first maximum vacuum level (P1) below atmospheric pressure.

18. The vacuum supply source (100) according to claim 1, wherein the first maximum vacuum level (P1) is −50 kPa below atmospheric pressure, and wherein the second maximum vacuum level (P2) is in a range of −70 kPa to −80 kPa.

19. The vacuum supply source (100) according to claim 1, further comprising at least one vacuum sensor (112, 122) located on the vacuum conduit (130), wherein the at least one vacuum sensor is connected to the at least one controller (150).

20. The vacuum supply source (100) according to claim 1, further comprising a first vacuum sensor (112) associated with the first vacuum pump (110) and located on the vacuum conduit (130) downstream the adjustable flow limiter (140) and a second vacuum sensor (122) associated with the second vacuum pump (120) and located on the vacuum conduit (130) upstream the flow limiter (140),
wherein the first and second vacuum sensors (112, 122) being connected to the at least one controller (150).
